(19) United States
(12) Patent Application Publication
(10) Pub. No.: US 2008/0007011 A1
(43) Pub. Date: Jan. 10, 2008

(54) Compressed gas cylinder valve seal having elastomeric overmolded surface

(76) Inventor: Henry Buermann, Brookfield, VT (US)

Correspondence Address: Kevin Ellicott, Esq., Suite 112, 1 Scale Avenue, Rutland, VT, 05701, US

(21) Appl. No.: 11/482,633

(22) Filed: Jul. 7, 2006

(51) Int. Cl. F02F 11/00

(52) U.S. Cl. 277/502

(57) ABSTRACT

A compressed gas cylinder valve seal comprising a non-metallic seal substrate having a top surface, and a bottom surface connected to one another along a circumferential skirt, an elastomeric material overmold retention channel passing completely through the seal substrate, an elastomeric material overmolded onto the top surface and the bottom surface and filling the elastomeric material overmold retention channel, and a gas passageway passing axially, completely through the non-metallic seal substrate.

### CROSS REFERENCE TO OTHER APPLICATIONS

This is the first submission of an application for this article of manufacture. There are no other applications, provisional or non provisional.

### FEDERALLY SPONSORED RESEARCH AND DEVELOPMENT

There are no federally sponsored or funded research or development projects or undertakings in any way associated with the instant invention.

### BACKGROUND OF THE INVENTION

1. Field of the Invention

The instant invention relates to that field of devices consisting of articles of manufacture known as seals. Specifically, the instant invention is a seal for use between a compressed gas regulator and a compressed gas cylinder valve.

2. Background Information

The prior art known to the Inventors discloses that various forms of seals are well known throughout the arts.

These seals are generally incorporated whenever metal (or a similar stiff material) and metal (or similar stiff material) are to be brought into physical contact, for the purpose of preventing gas or liquid from escaping at the metal to metal junction.

In general, seals of the sort represented by the instant invention are utilized most frequently in conjunction with pressurized gas tanks. The seal is frequently provided along with the tanks and or regulators and may be found in close association with the tank. The contents of pressurized gas tank are most often accessible through a valve that is attached to the tank. The valve, in turn, is often of the sort that has thereupon at least one gas passage means. It is this gas passage through which the pressurized contents of the tank is allowed to escape said tank. The valve further often includes means for attaching a regulator to the valve. In the sort of valve referred to herein, the means for attaching the regulator is a pair of blind holes, each having a bore, proximate to the gas passage means, and on the opposite side of the valve from said blind holes a dimple. The attachment of a regulator or similar device is most frequently accomplished by having the regulator itself removably connected to a valve clamping means which includes a retainer having a pair of pins and an opposite turnable screw, the turning of said screw pulling the regulator into contact with the valve gas passage means, while the pair of pins seat into the pair of blind holes, and both stabilize and guide the regulator into contact with the gas passage means.

The regulator is the means for measuring and metering the pressure and or volume of gas which is allowed to escape the pressurized tank. However, unless a seal is placed into the passage means before the regulator is attached, it is almost certain that pressurized gas will escape from between the regulator and the valve (most commonly the gas escaping through any nick or other slight deformation of the surfaces of the regulator which would contact the valve, and the valve gas passage).

Once the seal has been laid into the passage means, one must then “seat” the regulator into the valve. This is usually accomplished by twisting the screw found on the valve clamping means sufficiently so that the regulator is pressed firmly against the seal and the opposite side of the seal is pressed firmly against the valve passage means.

Unfortunately, in order to fully seat the regulator such that the seal can prevent the escape of any gas from between the valve and the regulator, most seals must be well compressed by the action of the regulator screw being twisted or turned enough times so that the mating surfaces of the regulator and the valve have sufficient contact against the seal. In so doing, many seals are permanently deformed and cannot be used a second time.

At present, there are two major types of seals which are generally used in the compressed gas industry; the metal-bound elastomeric washer and the plastic crush gasket. The plastic crush gasket is well known to be a single-use sort of gasket. When used only once, as per manufacturer's recommendations, few (if any) incidents have ever been traced back to gaskets of this sort. The metal-bound elastomeric washer has often been referred to as a multi-use sort, the assumption being that the elastomeric portion has a favorable rebound resilience and a low tendency to exhibit compression set, if not over torqued in use.

While the use of a non-reusable seal more than once is well known to potentially be a hazard and has been specifically discouraged both by manufacturers of the seals and various government regulatory bodies, it is further known that some users have nonetheless insisted on re-using non-reusable seals, due to ignorance and or negligence.

The inventor has discovered, however, that the assumption that a metal based ‘reusable’ seal is safer when reused, may well be false. In the fabrication of the metal-bound elastomeric washers it is commonplace to include portions of the metal substrate over which the overmolded elastomeric surface is attached, and which are essentially frangible. This is generally done in order to give adequate bonding surfaces for attachment of the elastomeric material to the metal substrate.

The frangible portions of the metal substrate are, at best, a hazard. These portions of the metal substrate may easily become stressed and fatigued during reuse of the seal. As a result, small portions of the metal substrate may break off or become dislodged and find their way into the valve, the regulator or even possibly the tank. And because the metal substrate is hidden from view by the overlay of elastomeric material, a visual inspection is highly unlikely to reveal that a portion of the metal substrate has broken free.

The presence of even nearly microscopic pieces of contaminants (the metal substrate which has broken free) in the regulator or valve or tank is well known to be an extremely serious hazard. The contaminant danger is further compounded when those contaminants are metal based. The metal particle can become the basis for a particle impact when introduced into the compressed gas stream, and a particle impact of this nature can provide a kindling path to the aluminum body of a tank or a regulator which may result in a catastrophic fire or explosion, due to the oxygen rich environment in many compressed gas cylinders.

Furthermore, it is well known that during the fabrication of metal-bound elastomeric sealing washers, the metallic portion is produced using a stamping process which includes a high pressure die applied in an environment rich in cutting oil. Cutting oil is a dangerous contaminant in that it may easily lead to flash fires in high pressure, oxygen rich environments. A seal which has been produced in this manner therefore runs a high chance of being contaminated before being assembled onto the valve and regulator.

The state of the art, then, is a situation where the desire for a seal which may withstand re-use is creating a much higher likelihood of exactly the same sort of danger which a non-reusable seal will prevent. However, given the fact that some users have ignored the injunction against reuse of non-reusable seals, it is currently thought that the dangers associated with seals having a metal substrate are outweighed by the perceived danger of re-use of a non-reusable seal.

The inventor has overcome both the problems associated with the improper re-use of a crush gasket and the potential for catastrophic explosions caused by metal and hydrocarbon contaminants created by metal-bound elastomeric sealing washers, through the invention of a compressed gas cylinder seal consisting of a plastic core which has an overmolded elastomeric surface. The overmolded elastomeric surface provides an adequate seal at the valve and regulator mating surfaces, while the plastic core is fabricated to avoid the inclusion of frangible portions which might break off and enter the compressed gas stream at any point.

### SUMMARY OF THE INVENTION

The instant invention is a valve seal, principally for use with pressurized gas tanks. For the first time, it is possible to seat the regulator into the valve of a pressurized gas tank with minimal effort and yet obtain the assurance of a strong, positive seal which will minimize leakage and without the possibility of metal fragments breaking free of the seal and acting as dangerous contaminants. And although the instant invention is generally referred to as being useful in connection with a pressurized gas tank, at the junction of the regulator and valve, it is entirely possible that it could be incorporated into myriad other situations where the contents of a container are under pressure, and a means for controllably withdrawing those pressurized contents is to be connected to the container. In any such situation where the container and withdrawing means have need for a seal at their interface, the instant invention may be superior to current, state of the art seals, without departing from the scope of the claims.

A first object of the instant invention, therefore, is to provide for a seal which will allow positive seating of the regulator into the valve passage means without the possibility of metal contaminants entering the compressed gas flow.

This objective is accomplished by fabricating a seal from appropriate non-metallic materials which are somewhat flexible, yet strong enough to withstand the pressure of tank contents against it, and overmolding an elastomeric surface onto the seal.

A second object of the instant invention is to provide for a seal which will allow positive seating of the regulator into the valve passage means even if the seal is reused, such reuse being at odds with the seal manufacturer's instructions, the equipment manufacturer's instructions, and instructions from various governmental agencies.

This objective is accomplished by fabricating a seal from appropriate non-metallic materials which are somewhat flexible, yet strong enough to withstand the pressure of tank contents against it, said seal being overmolded with an elastomeric surface capable of being deformed more than once and still maintaining a strong, positive seal between the regulator and the valve.

A third object of the instant invention is to provide for a seal which does not require a metal substrate to form the body of the seal, and yet is capable of retaining the elastomeric surface without delaminating during or after its expected one time use.

This objective is accomplished by fabricating the seal non-metallic substrate from appropriate non-metallic materials which are somewhat flexible, the seal having at least one retention channel passing therethrough such that the overmolded elastomeric material becomes integrated into the seal non-metallic substrate, and may not delaminate or pull free from the substrate.

### A DESCRIPTION OF THE DRAWINGS

FIG. 1 is a close up perspective view of a pressurized gas tank valve.

FIG. 2 is an elevational view of a typical regulator mounting yoke.

FIG. 3 is a close-up cross-sectional view a pressurized gas tank valve's passage means.

FIG. 4 is a perspective view of the seal non-metallic substrate.

FIG. 5 is an overhead view of the seal non-metallic substrate.

FIG. 6 is a side elevational view of the seal non-metallic substrate.

FIG. 7 is a side elevational cross section of the non-metallic substrate and overmolded elastomeric surface.

FIG. 8 is a perspective view of the instant invention.

### A DESCRIPTION OF THE PREFERRED EMBODIMENT

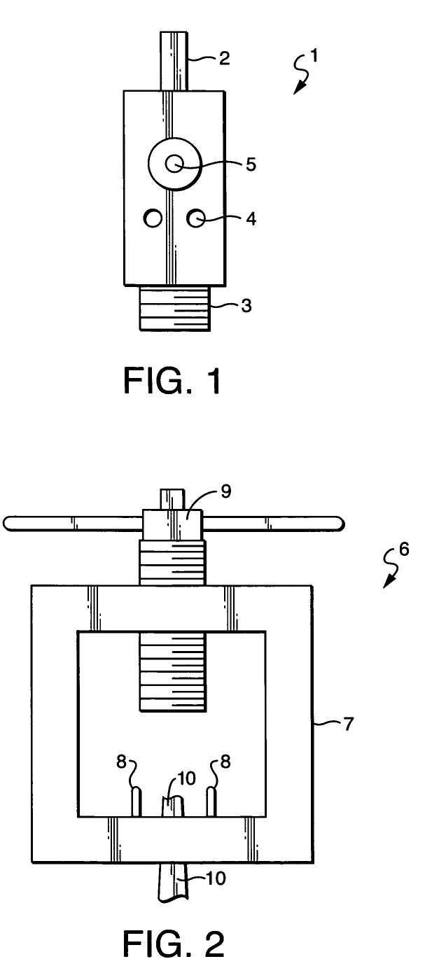

As per FIGS. 1 and 2, in the preferred embodiment a seal is constructed for use on a container of liquid or gas under pressure, the container generally being a cylinder. Such a cylinder will include a valve (1), the valve having a shut-off mechanism (2) and a threaded portion (3) for threadably engaging with and attaching to the cylinder.

The valve (1) of the sort referenced herein will also usually include a pair of holes, each hole having a blind bore (4). The valve will further usually include a gas passage means (5). The gas passage means is usually a hole communicating through the hollow interior of the valve, to the interior of the cylinder.

The container will also generally use a regulator to meter out and allow the escape from the container, in a controlled manner, the liquid or gas within the container. These regulators come in a wide variety of shapes and sizes, and the particular regulator used will be a function of choice or necessity driven by the requirements of whatever or whomever will consume the contents of the container. However, in order to provide a clear understanding of the invention, one particular form of regulator will be generally described. In this sort of regulator, attachment of the regulator to the valve is accomplished through the use of a valve clamping means (6), also known as a yoke, which includes a frame work acting as a retainer (7) having a pair of pins (8) and an opposite turnable screw (9), the turning of said screw pulling a regulator gas passage means (10) into contact with the valve gas passage means (5), while the pair of pins (8) seats into the pair of blind holes (4), both stabilizing and guiding the regulator gas passage means (10) into contact with the valve gas passage means (5).

What has been described thus far would be well known to anyone familiar with the art, and is presented merely to enable clear understanding of the detailed description of the seal, which follows. However, before describing the instant invention, it is useful to provide a still more detailed description of the prior art valve gas passage means (5) and the regulator gas passage means (10).

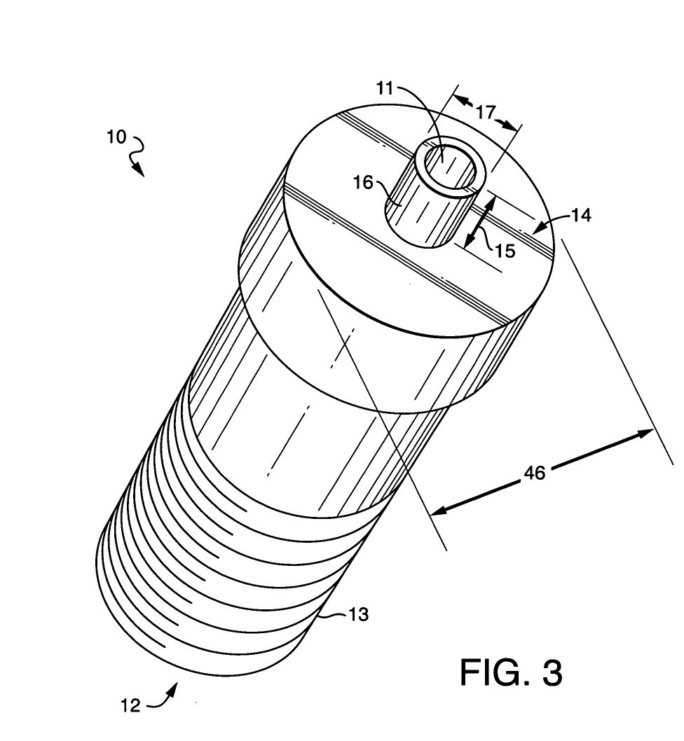

In the example described thus far, the regulator includes a regulator gas passage means (10). As per FIG. 3, this is usually a hollow stem having a gas passage nipple (16), the gas passage nipple having extending therethrough a first gas passage opening (11) at one end and a second gas passage opening (12) at the opposite end and having threads (13) proximate to one end for permitting attachment to the regulator. The regulator gas passage means (10) usually includes a shoulder area (14) which is a flat area surrounding the first gas passage nipple (16), the shoulder area generally having a shoulder area diameter (46). The first gas passage nipple is generally centered on the shoulder area (14) and extends upwardly and away from the shoulder area. The distance the first gas passage nipple extends upwardly and away from the shoulder area may be referred to as the first gas passage nipple height (15).

As gas must pass through the gas passage nipple, it clearly is also hollow. The gas passage nipple outside diameter (17) is therefore greater than the diameter of the gas passage opening (11).

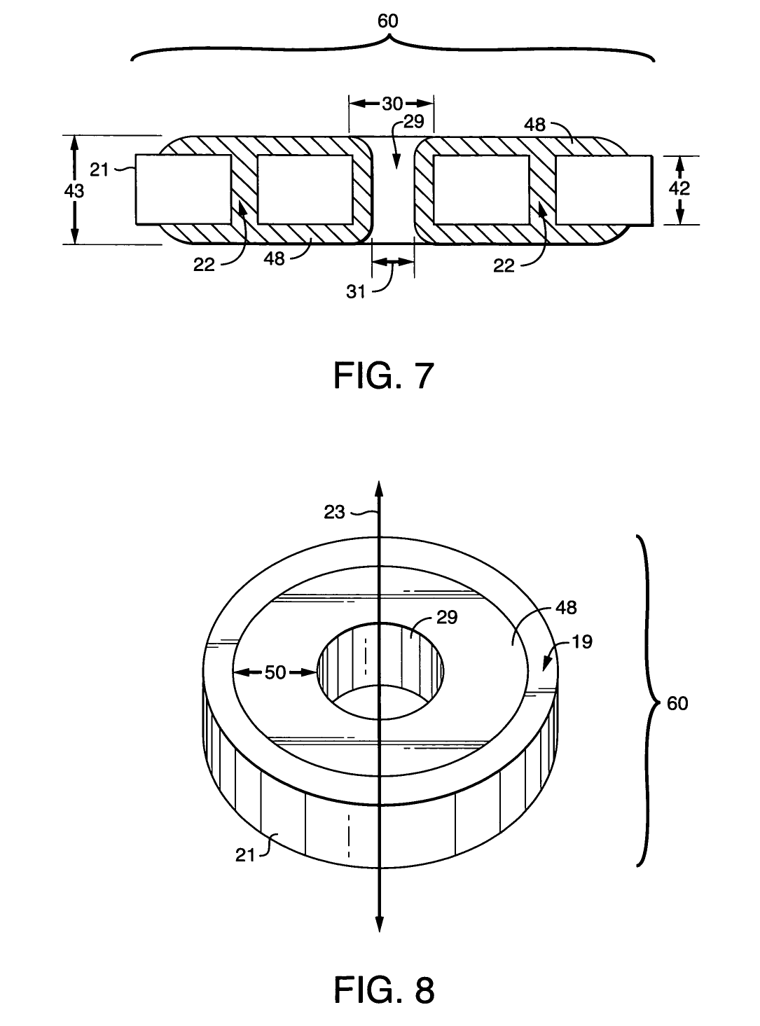

The instant invention, a compressed gas cylinder valve seal having elastomeric overmolded surface (60), as per FIGS. 7 and 8 will now be more particularly described.

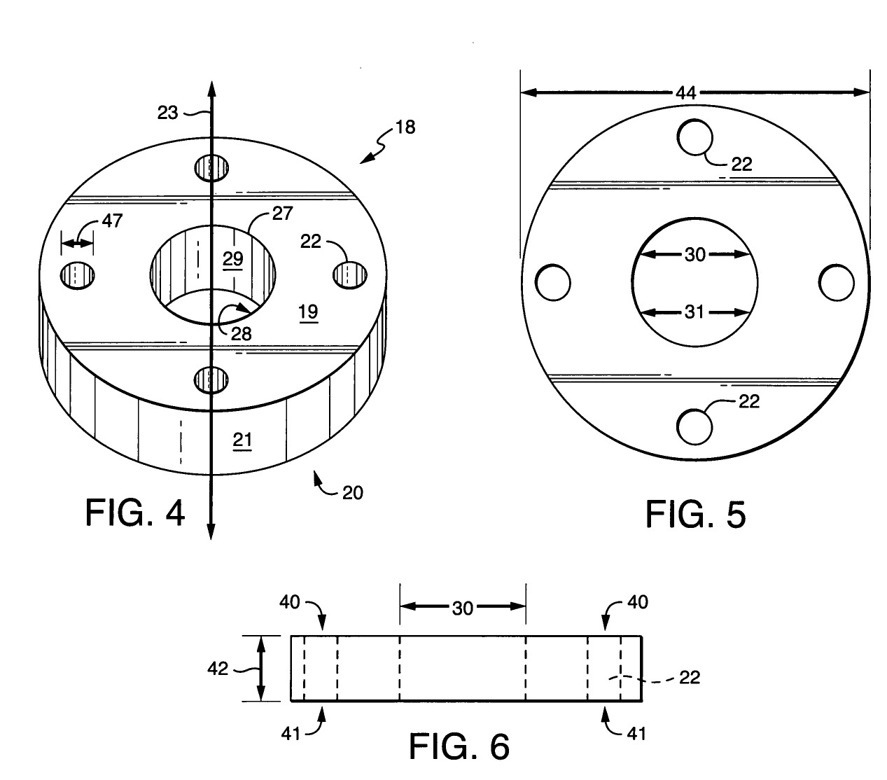

As per FIGS. 4 and 5 the instant invention is composed of a non-metallic seal substrate (18) having an overmolded elastomeric surface, preferably for use with gas cylinders of the sort having contents under high pressure and which use a valve and regulator to release the contents in a controlled manner.

The seal non-metallic substrate (18) is generally discoidal, having a top surface (19), an opposite bottom surface (20) and a circumferential skirt (21). The top surface and the bottom surface each merge into the skirt around the entire circumference of the seal non-metallic substrate. The seal non-metallic substrate further has at least one elastomeric overmold retention channel (22). In the preferred embodiment, there are a total of four such elastomeric overmold retention channels.

As per FIGS. 5 and 6, the seal non-metallic substrate has an outer diameter (44) and a thickness (42). It is preferred that the thickness (42) be no greater than the first gas passage nipple height (15), and that the outer diameter (44) be no approximate to the shoulder area diameter (46). In the preferred embodiment, the thickness (42) is approximately 0.061 inch and the outer diameter (44) is approximately 0.600 inch.

As per FIGS. 4 and 5, the seal non-metallic substrate (18) includes a first gas passage opening (27) passing through seal non-metallic substrate top surface (19), and a second gas passage opening (28) passing through the seal non-metallic substrate bottom surface (20). The seal non-metallic substrate first gas passage opening and the seal second gas passage opening are coextensive with one another and coaxial with one another and the center axis (23), thus together forming a seal non-metallic substrate gas passageway (29), such that fluid may enter the seal non-metallic substrate first gas passage opening, pass completely through the seal non-metallic substrate (via the seal gas passageway), and exit through the seal non-metallic substrate second gas passage opening. When the seal is in place, and the regulator is fully attached to the valve, gas under pressure may escape the container through the valve, passing through the seal, and into the regulator.

In the preferred embodiment, the seal non-metallic substrate first gas passage opening (27) has a diameter (30), and the seal non-metallic substrate second gas passage opening has a diameter (31). However, the precise diameter of the first gas passage opening and the second gas passage opening may be varied according to the needs of the particular valve and the particular regulator being used without departing from the scope of the claims. The diameter of the seal non-metallic substrate first gas passage opening and the seal non-metallic substrate second gas passage opening may be the same, or may differ. So long as the seal non-metallic substrate first gas passage opening diameter (30), and the seal non-metallic substrate second gas passage diameter (31) are greater than the gas passage nipple outside diameter (17), the instant invention will function as intended by the inventor. In the preferred embodiment, the seal non-metallic substrate first gas passage opening diameter (30), and the seal non-metallic substrate second gas passage diameter (31) are each equal to approximately 0.245 inch.

As noted earlier, the seal non-metallic substrate further has at least one elastomeric overmold retention channel (22). The seal non-metallic substrate elastomeric overmold retention channel may be identical in form to the seal non-metallic substrate gas passageway (29). That is, the seal non-metallic substrate elastomeric overmold retention channel may include a first retention channel passage opening (40) passing through seal non-metallic substrate top surface (19), and a second retention channel passage opening (41) passing through the seal non-metallic substrate bottom surface (20). The first retention channel passage opening and the second retention channel passage opening are coextensive with one another and coaxial with one another and thus together forming the elastomeric overmold retention channel (22), such that fluid may enter the first retention channel passage opening, pass completely through the seal non-metallic substrate (via the elastomeric overmold retention channel), and exit through the second retention channel opening. The elastomeric overmold retention channel (22) in the preferred embodiment is essentially tubular in form, and has channel diameter (47). While the precise diameter is variable, the inventor prefers the channel diameter to be 0.070 inch.

Have set forth the general arrangement of the seal non-metallic substrate, it is useful to provide a more detailed description of the elastomeric overmold, and how they cooperate to provide a more reliable and safer seal than was available in the past.

As is well known in the field of plastic molding, it is possible to apply an elastomeric material coating (48) to a substrate. Most often this is accomplished through what is generally referred to as the “two shot” process or the “overmolding” process. In this process, the substrate (a nylon disc in the preferred embodiment) is placed within a mold, and a liquefied form of an elastomeric material (for example, a polyolefinic block elastomer). One such example of an elastomeric material of this sort is known by the trade name “Duragrip”. In the preferred embodiment) is injected into the mold. The precise material used for the overmolded portion of the instant invention may be varied according to the user's desires, so long as it sets to a rubber-like consistency (man-made or artificial or synthetic rubber) and is somewhat flexible and somewhat compressible.

The overmolding process will not normally be used to coat the entire substrate. Rather, it is to be expected that only some portion of the substrate will actually be coated with the elastomeric material (48). In the case of the prefererred embodiment of the instant invention, the seal non-metallic substrate (18) is overmolded with the elastomeric material (48) such that the elastomeric material flows over the seal non-metallic substrate top surface (19) and the seal non-metallic substrate bottom surface (20), and the elastomeric overmold retention channel (22) is completely filled by the elastomeric material.

The mold used in this process will be fabricated such that the entire seal non-metallic substrate gas passageway (29) is not filled. Were the entire seal non-metallic substrate gas passageway (29) filled, it would be impossible for the instant invention to allow the passage of gas through it, and it would be useless for its intended purpose.

In the preferred embodiment, as per FIGS. 7 and 8, once the elastomeric material has been overmolded, the entire seal non-metallic substrate gas passageway (29) has a coated inner surface diameter (31) of 0.245 inch. Also, it is not necessary for the circumferential skirt (21) to be coated with the elastomeric material, for the invention to work as intended by the inventor.

While the preferred embodiment includes the seal non-metallic substrate gas passageway having a coating of the elastomeric overmolded material, it is not necessary for the operation of the instant invention. In fact, it may be desireable in some applications to have no coating on the seal non-metallic substrate gas passageway, or even having only a portion of the seal non-metallic substrate gas passageway coated with the elastomeric overmolded material.

It will also be recognized that once the elastomeric material has been overmolded onto the seal non-metallic substrate (18), the total thickness of the instant invention will be increased where the elastomeric material is present. While the seal non-metallic substrate thickness (42) was originally 0.061 inch, once the elastomeric material has been overmolded onto the seal non-metallic substrate top surface (19) and the seal non-metallic substrate bottom surface (20), the substrate plus elastomeric material thickness (43) will be greater than the seal non-metallic substrate thickness (42) alone. In the preferred embodiment, the substrate plus elastomeric material thickness (43) is approximately 0.091 inch.

To use the instant invention, the compressed gas cylinder valve seal having elastomeric overmolded surface is placed between the regulator and the valve and the regulator is tightened onto the valve (in the example at hand, by turning the screw (9)). The regulator is seated against the instant invention such that the regulator gas passage means shoulder area (14) is in direct contact with the elastomeric overmolded surface which coats the seal non-metallic substrate top surface (19). The elastomeric overmolded surface which coats the seal non-metallic substrate bottom surface (20) will be in direct contact with the valve (1), and will prevent the escape of gas or liquid from between the valve and the regulator. Use of the instant invention will both seal the regulator to the valve, as does the standard metal bound elastomeric washer today, but will also dramatically reduce the possibility that any contaminants broken lose from the substrate during use of the seal will enter the gas stream and pose a serious danger of explosion.

Given that the objective of the instant invention is to provide a safe, sound and stable seal between the regulator and the valve, it should be obvious that the seal non-metallic substrate top surface (19) and the seal non-metallic substrate bottom surface (20) must have sufficient overmolding with the elastomeric material. As has been pointed out, it is not necessary that the entire seal non-metallic substrate top surface (19) and the entire seal non-metallic substrate bottom surface (20) be overmolded with the elastomeric material. So long as the seal non-metallic substrate top surface (19) and the seal non-metallic substrate bottom surface are overmolded with a coating of elastomeric material sufficient to withstand the compression between the valve and the regulator, and the force of the compressed gas or fluid trying to escape between the valve and the regulator without failing or breaking apart, the device will function as intended. In the preferred embodiment, the overmold radial width (50) is approximately 0.550 inch.

Furthermore, as will be readily apparent to those in the art, the use of an elastomeric overcoating which is applied as a liquid, and which flows through at least one elastomeric overmold retention channel (22) such that the seal non-metallic substrate top surface (19) and the seal non-metallic substrate bottom surface (20) are not only coated by the elastomeric overcoating, but are further continuous with one another through that one elastomeric overmold retention channel (22), will greatly reduce the possibility of delamination of the overcoating from the substrate. In effect, the elastomeric overcoating on the seal non-metallic substrate top surface (19) and the elastomeric overcoating on the seal non-metallic substrate bottom surface (20) are both anchored to the non-metallic substrate, and bonded to one another, through the elastomeric overmold retention channel (22). Because the elastomeric retention channel (22) passes through the non-metallic substrate, it is surrounded by the non-metallic substrate completely, except at the first retention channel passage opening (40) passing through the seal non-metallic substrate top surface (19), and the second retention channel passage opening (41) passing through the seal non-metallic substrate bottom surface (20), where it is mereged into the elasomeric overmold material coating the top surface and the bottom surface. This provides a significant improvement over the prior art in that the elastomeric overmold material is not only bonded to the top and bottom surfaces of the seal non-metallic substrate, but also passes completely through the non-metallic substrate to provide additional attachment to the non-metallic substrate. For the first time, the elastomeric overcoating is bonded not only to a non-metallic substrate, but is bonded to said substrate through channels which are non-frangible and do not increase the likelihood that contaminants will break free of the seal during use. The use of elastomeric overmold retention channel (22) passing through the non-metallic substrate both increases the adhesion of the substrate to the elastomeric overcoating and decreases the possibility that frangible portions, or other weakened areas of the substrate will break off during use of the seal and endanger the user of the compressed gas cylinder.

It will be readily apparent to those familiar with the art that the various dimensions provided throughout the specification are merely examples, intended to remove the need for undue experimentation in order to accomplish the instant invention. They may easily be varied, so long as the instant invention will accomplish its stated objectives. Furthermore, the materials may be varied easily without departing from the claims so long as the non-metallic substrate is fabricated from a non-metallic material which is somewhat flexible and not brittle, and so long as the elastomeric overmolded surface is of a rubber-like consistency, being somewhat flexible and somewhat compressible.

I claim:

1. A compressed gas cylinder valve seal comprising:
A. a non-metallic seal substrate,
I. the non-metallic seal substrate having a top surface, an opposite bottom surface and a circumferential skirt,
a. the top surface and the bottom surface each merging into the circumferential skirt around the entire circumference of the seal substrate,
II. the non-metallic seal substrate having an elastomeric overmold retention channel passing completely therethrough,
III. the non-metallic seal substrate having a gas passageway passing axially completely therethrough,
B. an elastomeric material coating,
I. the elastomeric material coating being overmolded the non-metallic seal substrate top surface,
II. the elastomeric material coating being overmolded the non-metallic seal substrate bottom surface,
III. the elastomeric material coating filling the elastomeric overmold retention channel such that the elasomeric material coating overmolding the non-metallic seal substrate top surface is directly connected to the elastomeric material coating overmolding the non-metallic seal substrate bottom surface through the elastomeric overmold retention channel.

2. A compressed gas cylinder valve seal according to claim 1, further comprising:
A. at least a pair of elastomeric overmold retention channels.

3. A compressed gas cylinder valve seal according to claim 1, further comprising;
A. four elastomeric overmold retention channels.

4. A compressed gas cylinder valve seal according to claim 1, further comprising;
the non-metallic seal substrate gas passageway being overmolded with the elastomeric material.
